(19) United States
(12) Patent Application Publication
(10) Pub. No.: US 2014/0326348 A1
(43) Pub. Date: Nov. 6, 2014

(54) FLUID FLOW DIRECTOR

(71) Applicant: Access Business Group International LLC, Ada, MI (US)

(72) Inventors: Terry L. Lautzenheiser, Nunica, MI (US); Randall D. Betz, Caledonia, MI (US); Liane B. Hopaluk, Lowell, MI (US); Michael E. Miles, Grand Rapids, MI (US); David S. Vachon, Fennville, MI (US)

(73) Assignee: Access Business Group International LLC, Ada, MI (US)

(21) Appl. No.: 14/255,178

(22) Filed: Apr. 17, 2014

Related U.S. Application Data
(60) Provisional application No. 61/818,021, filed on May 1, 2013.

(51) Int. Cl. C02F 1/32

(52) U.S. Cl. CPC C02F 1/32
USPC 138/39; 29/428

(57) ABSTRACT

A fluid flow director for use in a water treatment system is provided. The fluid flow director is defined by a plastic sheet made up of a plastic substrate with a protective coating. The plastic substrate has fasteners disposed along two parallel edges thereof and the protective coating is substantially opaque to UV light. The plastic sheet is configured to be helically rolled such that the fasteners align and sealingly mate to form a tube. The fasteners are sized, constructed, and arranged to sealingly mate to form a substantially water-tight seam therebetween. In one embodiment, the plastic substrate is polyethylene and the UV opaque coating is polytetrafluoroethylene (“PTFE”).

### BACKGROUND OF THE INVENTION

The present invention relates generally to fluid flow directors, for example, fluid flow directors for use in water treatment systems in the presence of ultraviolet (UV) light.

Water treatment systems for filtering and treating contaminants in water are known. Many water treatment systems employ a fluid flow director or baffle in the water path to deflect, divert, check, regulate, or otherwise manipulate the flow or passage of water through the water treatment system. Because the fluid is in contact with the fluid flow director, the fluid flow director is typically manufactured from a material that will not leach impurities or otherwise taint the water. Often, these fluid flow directors are located in the presence of UV light. UV light has an inherent tendency to break down or otherwise adversely impact a range of materials, including many plastics. To avoid tainting the water and to withstand the UV light used in these water treatment systems, the fluid flow director is commonly made from stainless steel because of its physical properties and chemical inertness. Unfortunately, stainless steel is relatively expensive and results in a material increase in the overall cost of the water treatment system.

### SUMMARY OF THE INVENTION

One embodiment of the present invention provides a fluid flow director for use in a water treatment system. The fluid flow director is defined by a plastic member made up of a plastic substrate and a protective coating. The plastic substrate has fasteners disposed along two parallel edges thereof and the protective coating is substantially opaque to UV light. The plastic member is configured to be helically rolled such that the fasteners sealingly mate to form a substantially water-tight tube. The fasteners are sized, constructed, and arranged to sealingly mate to form a substantially water-tight seam therebetween. In one embodiment, the plastic substrate is polyethylene and the UV opaque coating is polytetrafluoroethylene (“PTFE”). In another embodiment, the fasteners are defined by a complementary groove and a ridge that are formed in continuous, elongated strips.

In another embodiment, a method of manufacturing a fluid flow director is provided where the method includes forming a flat plastic substrate that has integrally formed fasteners disposed along two parallel edges thereof. A protective coating that is substantially opaque to UV light is applied to a first surface of the plastic substrate, thereby forming a plastic sheet. The plastic sheet is then rolled into a cylindrical shape, and the mating fasteners are engaged to form the substantially water-tight seam, forming the fluid flow director.

In yet another embodiment, a fluid flow director is provided. The fluid flow director includes a plastic sheet made up of a plastic substrate having fasteners disposed along two parallel edges thereof and a protective coating that is substantially opaque to UV light. The plastic sheet is configured to be helically rolled such that the fasteners sealingly mate to form a substantially fluid-tight conduit. The thickness of the plastic substrate may be selected to provide the desired physical properties, for example, rigidity or pliability.

These and other objects, advantages, and features of the invention will be readily understood and appreciated by reference to the detailed description of the current embodiment and the drawings.

### BRIEF DESCRIPTION OF THE DRAWINGS

FIG. 1 is a sectional view of one embodiment of a water treatment system employing a fluid flow director with a UV opaque coating;

FIG. 2 is an exploded perspective view of a filter cartridge of the water treatment system shown in FIG. 1;

FIG. 3 is a plan view of a plastic sheet of a fluid flow director shown in FIG. 2;

FIG. 4 is a side view of the plastic sheet shown in FIG. 2;

FIG. 5 is a detail view of the encircled area of the fluid flow director;

FIG. 6 is a perspective view of the fluid flow director and a closed end cap of the filter cartridge shown in FIG. 2;

FIG. 7 is a plan view of a plastic sheet of a fluid flow director, according to another embodiment;

FIG. 8 is a side view of the plastic sheet shown in FIG. 7;

FIG. 9 is a perspective view of the fluid flow director formed from the plastic sheet shown in FIG. 7; and

FIG. 10 is a perspective view of the fluid flow director shown in FIG. 9 and a closed end cap of the filter cartridge shown in FIG. 2.

### DESCRIPTION OF THE CURRENT EMBODIMENT

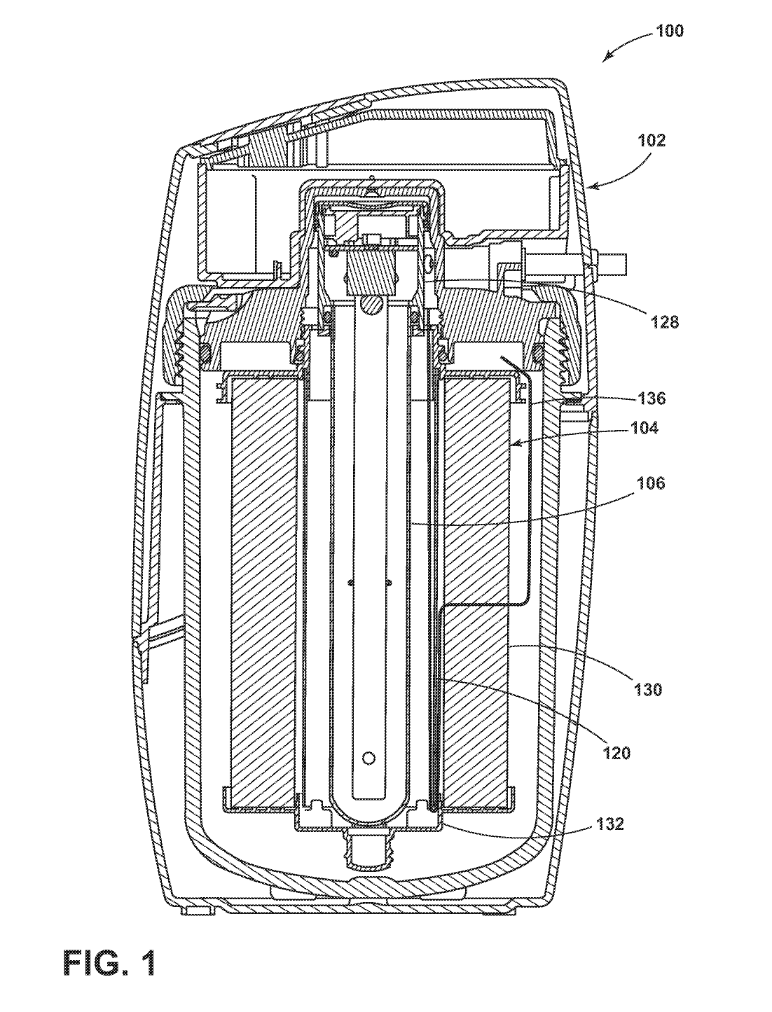

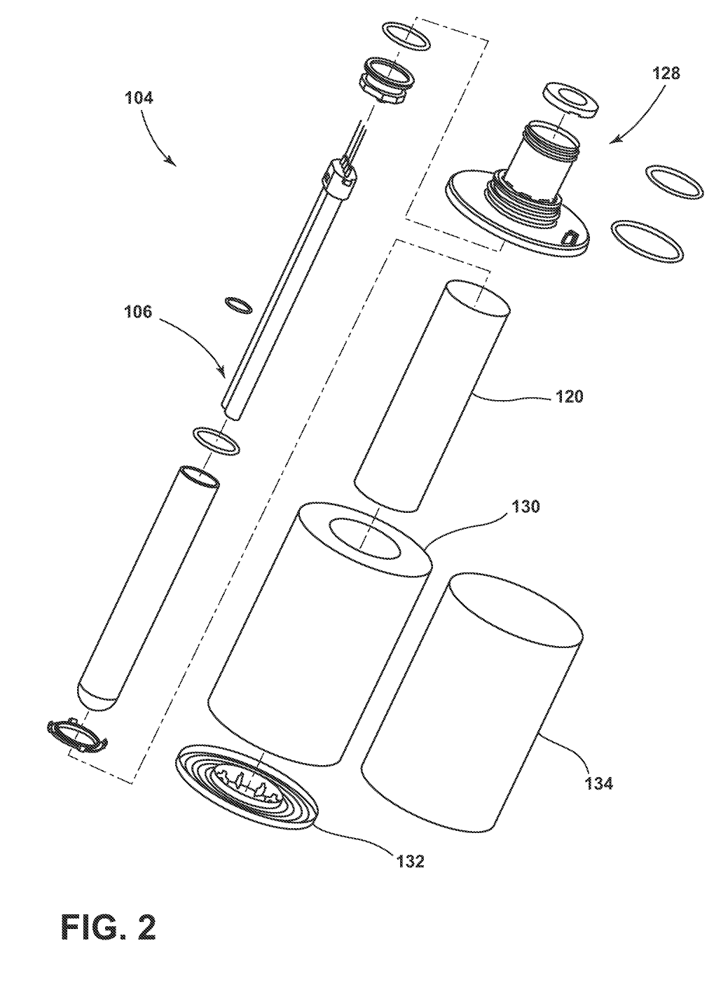

A water treatment system in accordance with an embodiment of the present invention is shown in FIG. 1 and generally designated 100. In this embodiment, the water treatment system generally includes a base unit 102 and a filter cartridge 104. A filter cartridge 104 in accordance with an embodiment of the present invention is shown in FIG. 2. The filter cartridge 104 of this embodiment includes, among other things, an ultraviolet (UV) light assembly 106 (including a quartz tube and UV lamp) and a fluid flow conduit referred to herein as plastic fluid flow director 120. The fluid flow director 120 is formed by a plastic member 122 that includes a plastic substrate 124 and a UV opaque coating 126. In a number of the embodiments described herein, the plastic member is a plastic sheet 122 and referred to as such. In alternative embodiments the plastic sheet can be replaced with essentially any other type of plastic member. The UV opaque coating 126 of the described embodiment may be made from unexpanded polytetrafluoroethylene (“PTFE”) and protects the plastic substrate 124 from being harmed by the UV light supplied by the UV light assembly 106. Although the illustrated embodiment is directed to a fluid flow director for a particular water treatment system, it should be understood that the invention is generally well-suited for use within essentially any other fluid flow system. For example, air treatment systems or different types of water treatment systems. Further, the fluid flow director may be used to deflect, divert, check, regulate, or otherwise manipulate the flow or passage of water through the water treatment system, air through an air treatment system, or any other fluid through a fluid treatment system.

Water treatment systems including various fluid flow directors are known. An alternate fluid flow director is described in co-owned U.S. Patent Application Publication No. 2008/0156717, published Jul. 3, 2008 to Hopaluk et al, which is hereby incorporated by reference in it entirety. The particular fluid flow director does not substantially alter the way in which the water treatment system works; accordingly, the water treatment system generally is not described in great detail herein. Although operation of the water treatment system is not described in great detail, a more detailed description of the operation and construction of a water treatment system is presented in co-owned U.S. Pat. No. 6,451,202, issued Sep. 17, 2002 to Kuennen et al, which is hereby incorporated by reference.

The components of one embodiment of a filter cartridge 104 are illustrated in FIG. 2 and include an open end cap 128, the UV light assembly 106, the fluid flow director 120 with the UV opaque coating 126, a carbon filter 130, a closed end cap 132, and an optional supplemental filter 134. The UV light assembly 106, fluid flow director 120 and carbon filter 130 coaxially interfit with the closed end cap 132, best shown in FIG. 1, such that there is a substantially cylindrical ring of space that separates the UV light assembly 106 from the fluid flow director 120, and a substantially cylindrical ring of space that separates the fluid flow director 120 from the carbon filter 130. The fluid flow director 120 and carbon filter 130 also coaxially interfit with the open end cap 128 such that as water passes through the carbon filter 130 it is diverted toward the closed end cap 132. In the current embodiment, the fluid flow director 120 is glued in place to the open end cap 128. The optional supplemental filter 134 is wrapped around carbon filter 130.

The flow of water through the current embodiment of the water treatment system 100 is shown in FIG. 1 as line 136. The water is fed to the system through filter cartridge 104, where it makes its way through the carbon filter 130. After the water passes through the carbon filter 130, the water is directed by the fluid flow director 120 toward the closed end cap 132. Upon reaching the closed end cap 132, water is allowed into the space between the UV light assembly 106 and the fluid flow director 120 for disinfection. After disinfection, the water is routed out of the filter cartridge 104 and water treatment system 100.

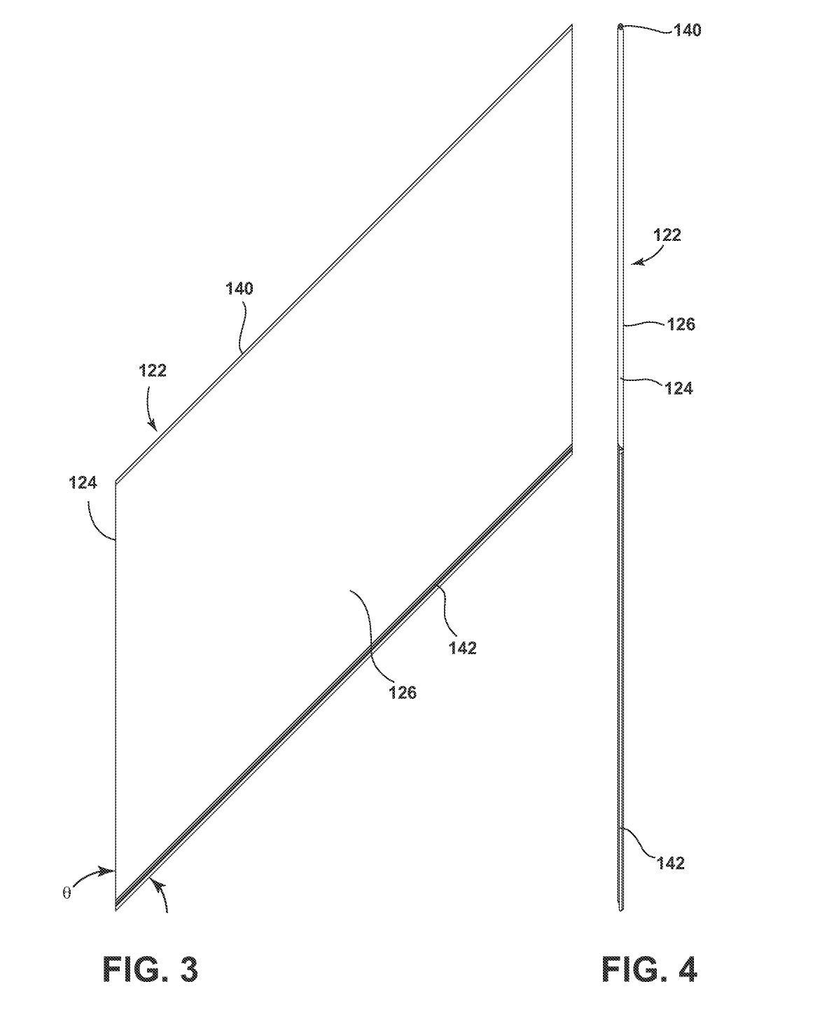

Referring now to FIGS. 3-6 the fluid flow director 120 is defined by the helically rolled plastic sheet 122 which is made of the plastic substrate 124 and the protective UV opaque coating 126. The plastic substrate 124 is a substantially flat sheet of plastic of a predetermined thickness. The specific type of plastic is described in detail hereinafter. The plastic substrate 124 may be formed through an extrusion process, by injection molding, or any other suitable manufacturing process. Further, the plastic substrate 124 may be provided in the shape of a rhombus and may include fasteners disposed along two parallel edges thereof. In the illustrated embodiment, the rhombus is shown to have approximately a 45° angle θ between adjacent sides. It should be understood however, that other angles θ are also contemplated.

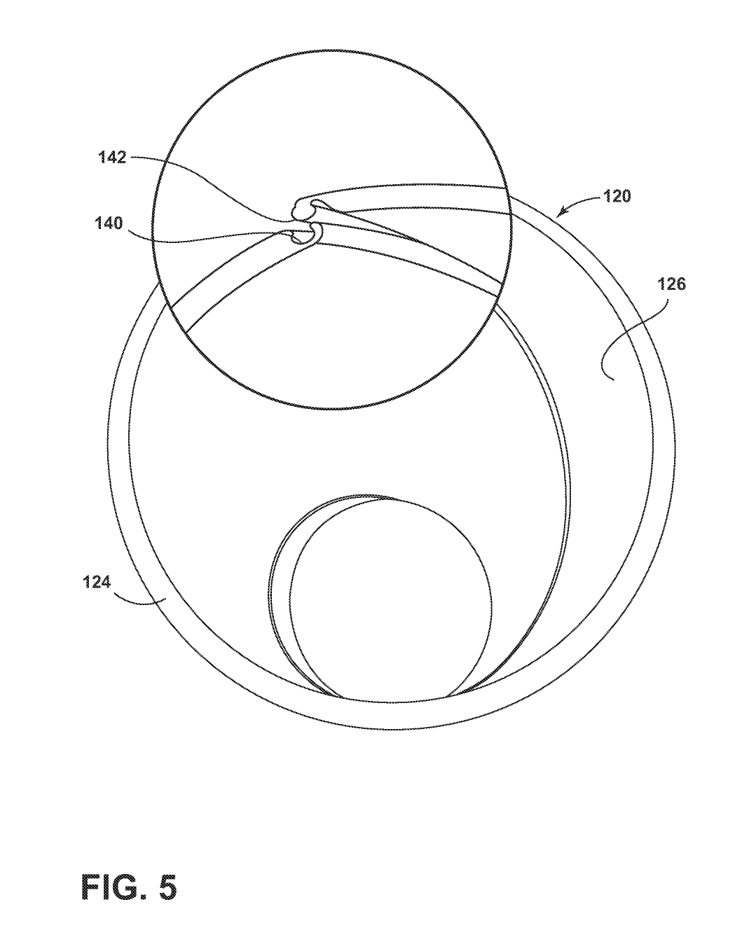

Referring to the detail view shown in FIG. 5, in one embodiment, the fasteners are defined by a complementary groove 140 and a ridge 142 configured to form a seam therebetween. The groove 140 and ridge 142 are formed within the material thickness of the plastic substrate 124 and function as a male and a female fastener. The groove 140 and ridge 142 are shaped to have substantially the same, yet complementary, profiles; the groove 140 is a rounded channel and the ridge 142 is a protruding rib with a bulbous head. The groove 140 and ridge 142 may be sized, constructed, and arranged to induce a friction fit therebetween to mate and form a substantially water-tight seal therebetween. It is also contemplated that the fastener may be sealed and resealed. Additionally, both the groove 140 and ridge 142 may be formed in continuous, elongated strips arranged along substantially the entire length of two parallel edges of the plastic substrate 124. Alternatively, the groove 140 and ridge 142 may be formed in discontinuous, intermittent, or spaced strips.

In the illustrated embodiment, the UV opaque coating 126 is applied to a single surface of the plastic substrate 124. Where desired, the UV opaque coating 126 may be applied to multiple surfaces. For example, in applications where multiple surfaces of the fluid flow director 120 are subjected to UV light, each of the surfaces impacted by UV light may be coated with a UV opaque coating. The characteristics of the UV opaque coating 126 may vary from surface to surface (or region to region) as dictated, for example, by the severity of UV exposure. Additionally, the UV opaque coating 126 may be co-extruded or co-injection molded with the plastic substrate 124.

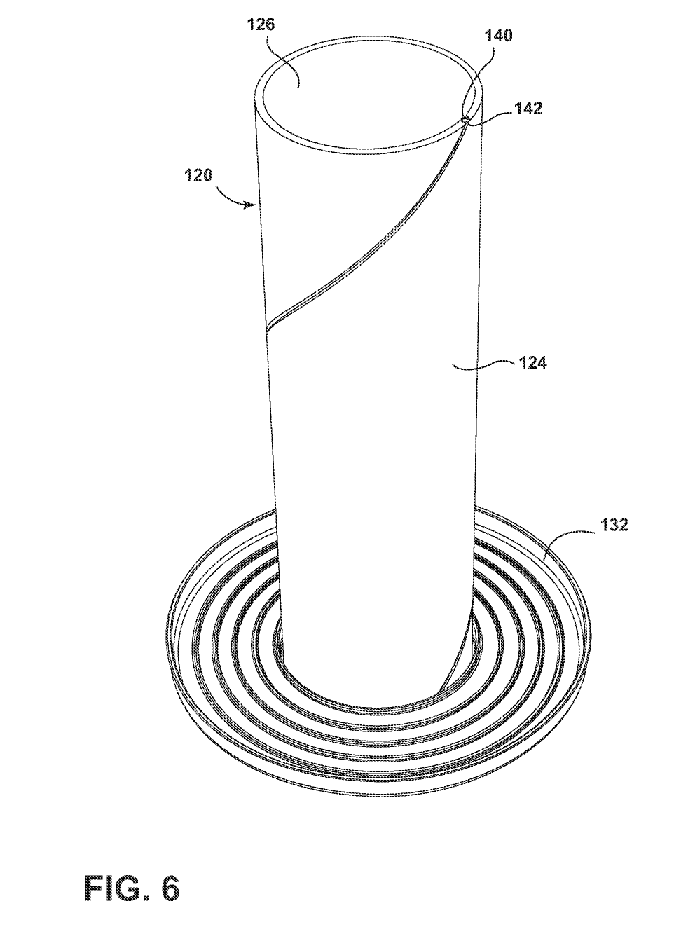

Referring now to FIG. 6, the plastic sheet 122 is configured to be helically rolled such that the fasteners 140, 142 sealingly mate to form a substantially water-tight tube or cylinder. When the plastic sheet 122 is rolled into a cylindrical shape, the groove 140 and ridge 142 become aligned, forming a seal that helically wraps around the fluid flow director 120. In this configuration, the UV opaque coating 126 is disposed on the interior surface of the fluid flow director 120. As mentioned above, however, both the interior and exterior surfaces may be coated with a UV opaque coating.

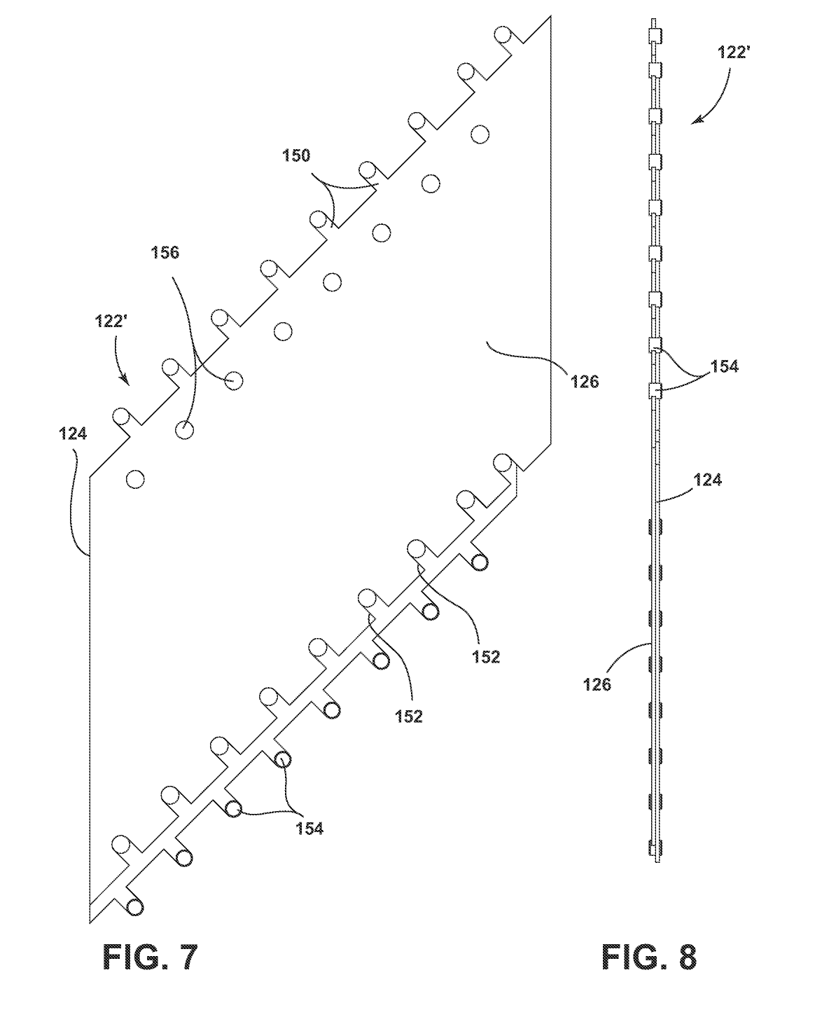

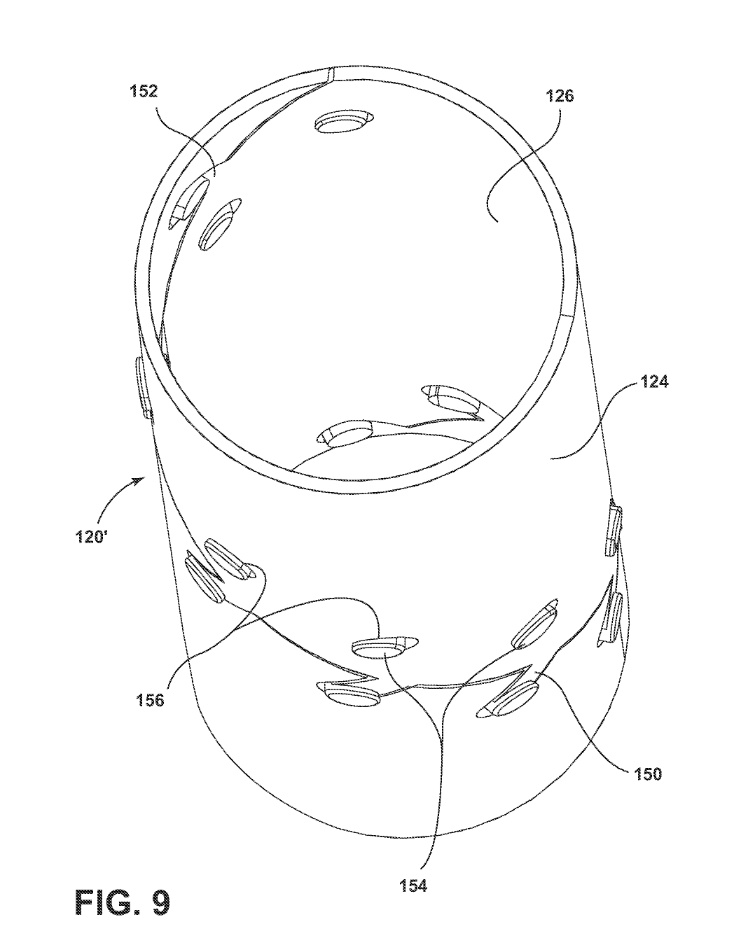

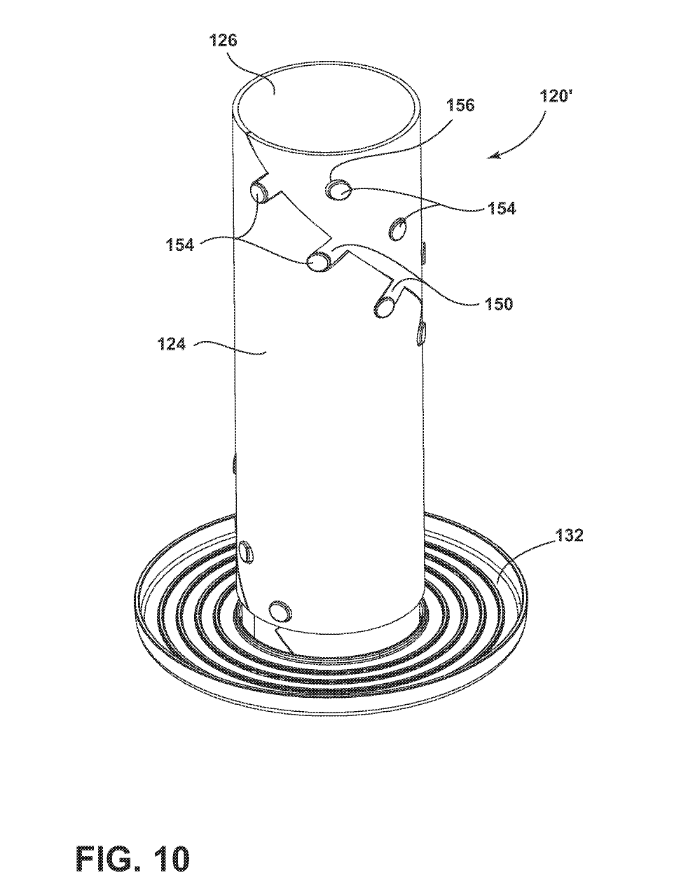

Referring now to FIGS. 7-10, an alternative embodiment is illustrated. In this embodiment, the fasteners are each defined by interlocking teeth in the form of a plurality of projections 150 and recesses 152 configured to form a seam therebetween. The plurality of projections 150 and recesses 152 interlock and function similar to a zipper. Further, each projection 150 includes, at a distal end thereof, a button 154 to be received in a coordinating aperture 156 located at a proximal end of the opposed recess 152. When the plastic sheet 122′ is helically rolled, the projections 150 are received within the coordinating recesses 152 and the buttons 154 are received within the coordinating apertures 156 to sealingly interlock and form a substantially water-tight tube or cylinder. When the plastic sheet 122′ is rolled into a cylindrical shape, the projections 150 and recesses 152 become aligned, forming a seam that helically wraps around the fluid flow director 120′. In this configuration, the projections 150 are arranged in an alternating over/under pattern. Also, the projections 150 and recesses 152 may be formed in continuous, elongated strips arranged along substantially the entire length of two parallel edges of the plastic substrate 124. Alternatively, the projections 150 and recesses 152 may be formed in discontinuous, intermittent, or spaced strips.

As described above, the fasteners are integrally formed with the plastic substrate 124. However, it is also contemplated that the fasteners, whether the groove 140 and ridge 142 or the projections 150 and recesses 152, may be provided as separate components. In this case, the fasteners could be bonded to the edges of the plastic substrate 124 using any suitable known means, including ultrasonic welding or adhesive. Additionally, a glue or adhesive may be added along the seam between the fasteners, to reinforce and/or enhance the seal therebetween.

The shape, size, composition and other characteristics of the fluid flow director 120, 120′ made from a plastic sheet 122, 122′ with a UV opaque coating 126 may vary from application to application. In the described embodiment, the plastic sheet 122, 122′ is ultra-high molecular weight polyethylene and the UV opaque coating 126 is polytetrafluoroethylene (“PTFE”). In the current embodiment, the fluid flow director 120, 120′ is shaped and sized as an open ended tube to interfit with the closed end cap 132 and the open end cap 128. The PTFE material of the current embodiment is Mupor™ Microporous PTFE available as part no. PM3VR from Porex Corporation at 500 Bohannon Road, Fairburn, Ga. 30213. The thickness of the PTFE material is believed to directly affect transparency and therefore the amount of protection provided from UV light. In the current embodiment, the PTFE coating is 8.5 mils thick. Spectrophotometer testing shows this thickness of PTFE to be sufficiently opaque to the UV wavelength of the current embodiment, 254 nanometers. Alternatively, the UV opaque coating may be in the form of a metal foil or a UV opaque paint.

The shape, size, composition and other characteristics of the plastic sheet 122, 122′ and UV opaque coating 126 are merely illustrative and are not intended to be limiting. For example, in some applications the plastic substrate may alternatively be manufactured from high or low density polyethylene and other similar polymeric materials. Further, the thickness of the plastic substrate may be selected to provide the desired physical properties, for example, rigidity or pliability. In another example, the plastic substrate may alternatively be manufactured from PTFE, and would therefore not require the UV coating layer. In applications where a coating of greater UV opacity is applied, it may be possible to use substrate materials with a lesser degree of resistance to damage from UV light. Also, the thickness or number of layers of the PTFE coating may be selected to control the opacity depending on the particular UV wavelength. As used herein, the term “opaque” is not intended to refer to absolute opacity, but rather is intended to denote a sufficient amount of opacity so as to protect the underlying substrate from an undesirable amount of decay over the life of the fluid flow director.

A method of manufacture and assembly of the fluid flow director 120 will now be described with reference to FIGS. 3-6. In general, the base material is formed in a flat plastic substrate 124 that includes integrally formed fasteners disposed along two parallel edges thereof. A protective UV opaque coating 126 is applied to a first surface of the plastic substrate 124, thereby forming the plastic sheet 122. In one embodiment, the plastic sheet 122 is extruded and then cut to length in the shape of a rhombus. Additionally, the UV opaque coating 126 may be co-extruded with the plastic substrate 124. Alternatively, the plastic sheet 122 may be formed using injection molding, and the UV opaque coating 126 may be co-injection molded with the plastic substrate 124.

To assemble the fluid flow director 120, the plastic sheet 122 is helically rolled or wrapped into a cylindrical shape. The plastic sheet 122 may be rolled upon itself, or wrapped around an assembly aid to form the cylinder. Regardless, in this orientation, the mating fasteners are aligned and can be engaged. In the case of the groove 140 and ridge 142 embodiment, the ridge 142 is positioned over the groove 140 and pressed down into the groove 140 to form a substantially water-tight seal therebetween and the fluid flow director 120. With reference to the embodiment shown in FIGS. 7-10, the coordinating projections 150 and recesses 152 are aligned and the buttons 154 are received in the coordinating apertures 156. The projections/recesses 150/152 and buttons/apertures 154/156 are aligned in an alternating over/under pattern and engage to form a substantially water-tight seam therebetween, thereby completing assembly of the fluid flow director 120′. It should be noted that in some embodiments, the final assembly of the fluid flow director may be performed, without the use of tools, by hand assembly.

Advantageously, the plastic sheet 122, 122′ is a flat member that is readily stacked, packaged, and shipped from one manufacturing site to another. It is contemplated that the plastic sheet 122, 122′ could be manufactured at one facility, possibly a supplier, and then transported to a second facility for final assembly. Currently, cylindrical fluid flow directors are packaged and shipped to the water treatment system assembly location. This is much less efficient because cylinders are much less densely packaged as compared to flat sheets. The ability to instead ship flat plastic sheets 122, 122′ lowers the cost of shipping.

Additionally, the present invention enables the fluid flow director 120, 120′ to be assembled at any desired point in time subsequent to the manufacture of the plastic sheet 122, 122′. Presently, assembling fluid flow directors requires the use of specialized tools, so they are manufactured and then assembled prior to being delivered to the water treatment system assembly location. Advantageously, assembly of the fluid flow director 120, 120′ does not require the use of tools; therefore, assembly can occur right on the water treatment system assembly line if desired. Of course, the fluid flow director 120, 120′ may be assembled at any feasible time and location and is not limited to only the instances described herein.

Yet another benefit of the embodiments described herein is the increased strength that the helically rolled fluid flow director 120, 120′ offers, as compared to a tube with straight seam that lies parallel to the axis of the cylinder. Further, helically rolling the fluid flow director 120, 120′ provides for a substantially circular, not tear-drop or other, shaped cross-section.

Although the invention has been described with respect to the illustrated water treatment system, it should be understood that the invention could be implemented in essentially any water treatment system where it is desirable to dispose a fluid flow director or baffle in the presence of UV light. The above description is that of the current embodiment of the invention. Various alterations and changes can be made without departing from the spirit and broader aspects of the invention.

The embodiments of the invention in which an exclusive property or privilege is claimed are defined as follows:

1. A fluid flow director for use in a water treatment system comprising:
a plastic member comprising:
a plastic substrate having integrally formed fasteners disposed along two parallel edges thereof; and
a protective coating that is substantially opaque to UV light;
wherein the plastic member is configured to be helically rolled such that the fasteners sealingly mate to form a substantially water-tight tube.

2. The fluid flow director according to claim 1, wherein the plastic member is a sheet formed in the shape of a rhombus such that when the plastic sheet is helically rolled a right circular cylinder having planar circular ends is formed.

3. The fluid flow director according to claim 2, wherein the fasteners are defined by a complementary groove and a ridge.

4. The fluid flow director according to claim 3, wherein the groove and the ridge are sized, constructed, and arranged to sealingly mate to form a substantially water-tight seam.

5. The fluid flow director according to claim 4, wherein both the groove and the ridge are formed in continuous, elongated strips.

6. The fluid flow director according to claim 2, wherein the fasteners are each defined by interlocking teeth.

7. The fluid flow director according to claim 6, wherein the fastener teeth are in the form of a plurality of projections having a plurality of recesses therebetween.

8. The fluid flow director according to claim 7, wherein the plurality projections and recesses are formed in a continuous, elongated strip.

9. The fluid flow director according to claim 8, wherein the plurality of projections and recesses function similar to a zipper and interlock to form a substantially water-tight seam.

10. The fluid flow director according to claim 1, wherein the protective coating is disposed on an inner surface of the helically rolled tube.

11. A method of manufacturing a fluid flow director, comprising the steps of:
forming a flat plastic substrate that includes integrally formed fasteners disposed along two parallel edges thereof;
applying a protective coating that is substantially opaque to UV light to a first surface of the plastic substrate, thereby forming a plastic sheet;
helically rolling the flat plastic sheet into a cylindrical shape; and
engaging the mating fasteners to form the substantially water-tight seam, thereby forming the fluid flow director.

12. The method of manufacturing a fluid flow director according to claim 11, wherein the plastic sheet is formed in the shape of a rhombus such that when the plastic sheet is helically rolled, a right circular cylinder having planar, circular ends is formed.

13. The method of manufacturing a fluid flow director according to claim 12, wherein the plastic substrate is formed by extrusion.

14. The method of manufacturing a fluid flow director according to claim 13, wherein the protective UV coating is co-extruded with the plastic substrate.

15. The method of manufacturing a fluid flow director according to claim 12, wherein the plastic substrate is formed by injection molding.

16. The method of manufacturing a fluid flow director according to claim 15, wherein the protective UV coating is co-injection molded with the plastic substrate.

17. The method of manufacturing a fluid flow director according to claim 11, wherein the flat plastic sheet can be assembled into the cylindrical fluid flow director without the use of tools.

18. A fluid flow director comprising:
a plastic sheet comprising:
a plastic substrate having fasteners disposed along two parallel edges thereof; and
a protective coating that is substantially opaque to UV light;
wherein the plastic sheet is configured to be helically rolled such that the fasteners sealingly mate to form a substantially fluid-tight conduit.

19. The fluid flow director according to claim 18, wherein the protective coating is disposed on an inner surface of the helically rolled conduit.

20. The fluid flow director according to claim 19, wherein the plastic sheet is formed in the shape of a rhombus such that when the plastic sheet is helically rolled, a right circular cylinder having planar, circular ends is formed.

21. The fluid flow director according to claim 18, wherein the fasteners are defined by one of 1) a complementary groove and a ridge, and 2) a plurality of interlocking teeth.

22. The fluid flow director according to claim 18, wherein the fluid flow director is used to manipulate or facilitate the flow of fluid in one of a water treatment system and an air treatment system.
